(19) United States
(12) Patent Application Publication
(10) Pub. No.: US 2003/0160983 A1
(43) Pub. Date: Aug. 28, 2003

(54) Method and apparatus to convert a level of an image

(75) Inventor: Eul-hwan Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/337,892

(22) Filed: Jan. 8, 2003

(30) Foreign Application Priority Data
Feb. 26, 2002 (KR) 2002-10263

(51) Int. Cl. G06F 15/00; B41J 1/00

(52) U.S. Cl. 358/1.9

(57) ABSTRACT

An apparatus and method thereof to convert a level of an image includes a threshold value generator and a level converter. The threshold value generator considers at least two color components an input pixel has as the same color component, produces threshold values for the color components, and outputs the produced threshold values. The level converter converts a multi-valued luminance level of the input pixel into a bi-valued luminance level with reference to the threshold values, and outputs the bi-valued luminance level.

### CROSS-REFERENCE TO RELATED APPLICATIONS

This application is based upon and claims priority from Korean Patent Application No. 2002-10263 filed Feb. 26, 2002 in the Korean Intellectual Property Office, the disclosure of which is incorporated herein by reference.

### BACKGROUND OF THE INVENTION

1. Field of the Invention

The present invention relates to image processing, and more particularly, to a method and apparatus to convert a level of an image signal by converting a luminance level of the image signal.

2. Description of the Related Art

A halftoning method, that is, a method to convert a level of an image is a technique of converting a level of a continuous gradational image by converting a multi-valued luminance level of the continuous gradational image into a bi-valued luminance level. Here, the multi-valued luminance level is a luminance level that falls within a range of 0-2ⁿ, and the bi-valued luminance level is a luminance level of 0 or 2ⁿ (n is a positive integer more than 1).

In general, the halftoning method is widely used in digital copy machines, laser printers, ink-jet printers and facsimile machines, and is classified largely as an ordered dithering method and an error diffusion method.

Hereinafter, a conventional halftoning method to convert the level of the image will be explained. According to the conventional method, first, an optimum distance and a minimum distance between an input pixel and pixels adjacent to the input pixel are determined according to a color of the input pixel. At this time, a threshold value is obtained using the determined optimum distance and minimum distance, and the multi-valued luminance level is binarized into the bi-valued luminance level based on the threshold value. In general, in the event that conventional halftoning is used to convert the multi-valued luminance level of the input pixel into the bi-valued luminance level with respect to cyan, magenta, and yellow components, the bi-valued luminance level of an output pixel is regularly distributed in each color component. However, this conversion is performed not in consideration of influences the color components have upon each other, and thus, the conventional halftoning method may produce an unevenly bi-valued image due to interferences between the cyan and magenta components. Here, the bi-valued image is referred to as the image including bi-valued luminance levels that are converted from the multi-valued luminance levels.

### SUMMARY OF THE INVENTION

In accordance with an aspect of the present invention, there is provided an image conversion method to produce a high-quality bi-valued image by converting a multi-valued luminance level into a bi-valued luminance level in consideration of interferences between color components.

In accordance with an aspect of the present invention, there is provided an image conversion apparatus to perform such a method.

In accordance with an aspect of the present invention, there is provided a method to convert the level of an image, the method including considering at least two color components that an input pixel has as the same color component, and producing threshold values for each color component; and converting a multi-valued luminance level of the input pixel into a bi-valued luminance level using the threshold values.

In accordance with an aspect of the present invention, there is provided an apparatus to convert the level of an image, the apparatus including a threshold value generator considering at least two color components an input pixel has as the same color component, producing threshold values for the color components, and outputting the produced threshold values; and a level converter to convert a multi-valued luminance level of the input pixel into a bi-valued luminance level with reference to the threshold values, and outputting the bi-valued luminance level.

In accordance with an aspect of the present invention, there is provided a method to convert a level of an image including regularly distributing parts corresponding to color components of an input pixel in a bright portion of a bi-valued luminance level when converting a multi-valued luminance level into the bi-valued luminance level to improve a quality of an output image having the bi-valued luminance level.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and other aspects and advantages of the invention will become apparent and more readily appreciated from the following description of the embodiments, taken in conjunction with the accompanying drawings of which:

FIG. 1 is a flow chart explaining an image conversion method according to an aspect of the present invention;

FIG. 2 is a block diagram of an image conversion apparatus to perform the method of FIG. 1;

FIG. 3 is a block diagram of a second distance calculator illustrated in FIG. 1, according to an aspect of the present invention;

FIG. 4 is a block diagram of a threshold value calculator illustrated in FIG. 2, according to an aspect of the present invention;

FIG. 5 is a block diagram of the threshold value calculator of FIG. 2, according to an aspect of the present invention; and

FIG. 6 is a block diagram of a level converter in FIG. 2, according to an aspect of the present invention.

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures. to convert the level of an image will be explained with reference to the accompanying drawings.]

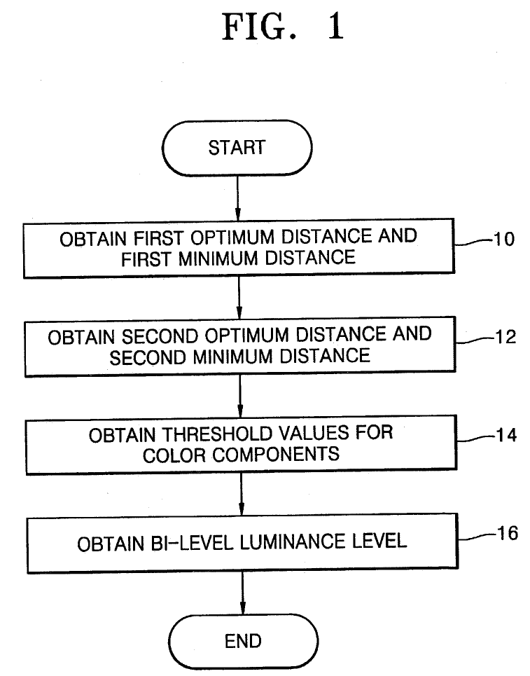

FIG. 1 is a flow chart explaining an image conversion method, according to an aspect of the present invention, by converting a multi-valued luminance level of an input pixel into a bi-valued luminance level. FIG. 1 includes the image conversion method to obtain a threshold value of each color component (operations 10-14), and to obtain the bi-valued luminance level thereof (operation 16).

In the image conversion method, according to an aspect of the present invention, first, the threshold value of each color component is produced on an assumption that at least two of at least three color components that the input pixel may have are the same (operations 10-14). Here, the at least three color components that the input pixel may have may be cyan, magenta, and yellow components, and in this case, the at least two color components are cyan and magenta components.

More specifically, at operation 10, an appropriate distance between output pixels having the bi-valued luminance levels, i.e., a first optimum distance, is obtained for the at least two color components according to the multi-valued luminance level of the input pixel, and then, a distance between the input pixel and a minor pixel nearest to the input pixel, i.e., a first minimum distance, is respectively obtained for at least two color components. Here, the minor pixel is a black pixel when the multi-valued luminance level of the input pixel is larger than or the same as an intermediate luminance level 2ⁿ⁻¹(n is a positive integer more than 1), which becomes a white pixel when the multi-valued luminance level is smaller than the intermediate luminance level 2ⁿ⁻¹. Here, the multi-valued luminance level denotes a luminance level that falls within a range of 0-2ⁿ, and the intermediate luminance level denotes an intermediate level among luminance levels that the multi-valued luminance level may have.

For instance, the first optimum distance and the first minimum distance between pixels are each obtained with respect to the cyan component, and the magenta component. Here, the first minimum distance can be obtained from predetermined bi-valued luminance levels, or a method to obtain the first minimum distance between pixels is disclosed in Korean Patent Application No. 1999-53325 entitled “Image Quantization Method for obtaining Regularly Distributed Dots of Bi-Valued Image by Keeping Optimum Distance”, and Korean Patent Application No. 2000-258 entitled “Color Halftoning Processing Apparatus.”

After operation 10, at operation 12, a second optimum distance between the output pixels having one of the at least two color components is obtained according to the multi-valued luminance level of the input pixel, and then, a shortest distance from the first minimum distances obtained with respect to the at least two color components is determined to be a second minimum distance. For instance, the second optimum distance between the output pixels corresponding to one of the cyan and magenta components is obtained, and then, the shorter one from first minimum distances with respect to the cyan and magenta components is determined as the second minimum distance. Here, the second minimum distance is a distance between the output pixels having the cyan or magenta color nearest to the input pixel positioned at a point (m,n).

Here, it is assumed that the first optimum distance dₒₚₜ(i₁(m,n)) for of a first color component, which is one of the at least two color components, is expressed as the following equation 1 and the first optimum distance dₒₚₜ(i₂(m,n) of a second color component, which is the other of the at least two color component, is expressed as the following equation 2:

$${d}_{opt} ( {i}_{1} ( m , n ) ) = \{ \begin{matrix}\frac{1}{\sqrt{\frac{{i}_{1} ( m , n )}{{2}^{n}}}} , if {i}_{1} ( m , n ) \leq {2}^{n - 1} \\ \frac{1}{\sqrt{1 - \frac{{i}_{1} ( m , n )}{{2}^{n}}}} , if {i}_{1} ( m , n ) > {2}^{n - 1}\end{matrix} \qquad ( 1 )$$

wherein i₁(m,n) denotes the multi-valued luminance level of the first color component of the input pixel positioned at a point (m,n); and

$${d}_{pot} ( {i}_{2} ( m , n ) ) = \{ \begin{matrix}\frac{1}{\sqrt{\frac{{i}_{2} ( m , n )}{{2}^{n}}}} , if {i}_{2} ( m , n ) \leq {2}^{n - 1} \\ \frac{1}{\sqrt{1 - \frac{{i}_{2} ( m , n )}{{2}^{n}}}} , if {i}_{2} ( m , n ) > {2}^{n - 1}\end{matrix} \qquad ( 2 )$$

wherein i₂(m,n) denotes a multi-valued luminance level of the second color component of the input pixel at the point (m,n).

Equations 1 and 2 reveal that the more the multi-valued luminance level i₁(m,n) or i₂(m,n) of the input pixel approaches the intermediate luminance level 2ⁿ⁻¹, the more the first optimum distance dₒₚₜ(i₁(m,n)) or dₒₚₜ(i₂(m,n)) decreases. Also, the more the multi-valued luminance level i₁(m,n) or i₂(m,n) of the input pixel approaches a lowest luminance level 0 or a highest luminance level 2ⁿ, the more the first optimum distance dₒₚₜ(i₁(m,n)) or dₒₚₜ(i₂(m,n)) increases.

The second optimum distance dₒₚₜ(N₁₂) can be obtained using the following equation 3:

$${d}_{opt} ( {N}_{12} ) = \{ \begin{matrix}\frac{1}{\sqrt{\frac{{N}_{12}}{{2}^{n}}}} , if {N}_{12} \leq {2}^{n - 1} \\ \frac{1}{\sqrt{1 - \frac{{N}_{12}}{{2}^{n}}}} , if {N}_{12} > {2}^{n - 1}\end{matrix} \qquad ( 3 )$$

Here, N₁₂ is expressed as in the following equation 4:

N₁₂=N₁+N₂ . . . (4)

wherein N1 denotes a number of minor pixels for the first color component, and N2 denotes a number of minor pixels for the second color component. N1 and N2 are respectively determined using equations 5 and 6:

$$\begin{matrix}{N}_{1} = \{ \begin{matrix}{i}_{1} ( m , n ) , if {i}_{1} ( m , n ) \leq {2}^{n - 1} \\ {2}^{n} - {i}_{1} ( m , n ) , if {i}_{1} ( m , n ) > {2}^{n - 1}\end{matrix} & ( 5 ) \\ {N}_{2} = \{ \begin{matrix}{i}_{2} ( m , n ) , if {i}_{2} ( m , n ) \leq {2}^{n - 1} \\ {2}^{n} - {i}_{2} ( m , n ) , if {i}_{2} ( m , n ) > {2}^{n - 1}\end{matrix} & ( 6 )\end{matrix}$$

According to an aspect of the present invention, although operation 10 is illustrated to be performed prior to operation 12 in FIG. 1, it is possible to perform operation 10 after operation 12, or perform operations 10 and 12 at once.

After operation 12, at operation 14, a threshold value for each color component is obtained using the first and second optimum distances, and the first and second minimum distances. For instance, threshold values t₁(m,n), t₂(m,n) and t₃(m,n) for color components are computed using the following equation 7, using the first optimum distance expressed in the aforementioned equations 1 and 2, the second optimum distance expressed in the equation 3, and the first minimum distance and second minimum distance:

$${t}_{1} ( m , n ) = \{ \begin{matrix}{2}^{n - 1} - {A}_{1} \times [ {d}_{min} ( {i}_{1} ( m , n ) ) - {d}_{opt} ( {i}_{1} ( m , n ) ) - {B}_{1} \times ( {d}_{min} ( {N}_{12} ) - {d}_{opt} ( {N}_{12} ) ) ] , if {i}_{1} ( m , n ) \leq {2}^{n - 1} \\ {2}^{n - 1} + {A}_{1} \times [ {d}_{min} ( {i}_{1} ( m , n ) ) - {d}_{opt} ( {i}_{1} ( m , n ) + {B}_{1} \times ( {d}_{min} ( {N}_{12} ) - {d}_{opt} ( {N}_{12} ) ) ] , if {i}_{1} ( m , n ) > {2}^{n - 1}\end{matrix} \\ {t}_{2} ( m , n ) = \{ \begin{matrix}{2}^{n - 1} - {A}_{2} \times [ {d}_{min} ( {i}_{2} ( m , n ) ) - {d}_{opt} ( {i}_{2} ( m , n ) ) - {B}_{2} \times ( {d}_{min} ( {N}_{12} ) - {d}_{opt} ( {N}_{12} ) ) ] , if {i}_{2} ( m , n ) \leq {2}^{n - 1} \\ {2}^{n - 1} + {A}_{2} \times [ {d}_{min} ( {i}_{2} ( m , n ) ) - {d}_{opt} ( {i}_{2} ( m , n ) + {B}_{2} \times ( {d}_{min} ( {N}_{12} ) - {d}_{opt} ( {N}_{12} ) ) ] , if {i}_{2} ( m , n ) > {2}^{n - 1}\end{matrix} \\ {t}_{3} ( m , n ) = \{ \begin{matrix}{2}^{n - 1} - {A}_{3} \times [ {d}_{min} ( {i}_{3} ( m , n ) ) - {d}_{opt} ( {i}_{3} ( m , n ) ) ] , if {i}_{3} ( m , n ) \leq {2}^{n - 1} \\ {2}^{n - 1} + {A}_{3} \times [ {d}_{min} ( {i}_{3} ( m , n ) ) - {d}_{opt} ( {i}_{3} ( m , n ) ] , if {i}_{3} ( m , n ) > {2}^{n - 1}\end{matrix} \qquad ( 7 )$$

wherein A₁, A₂, A₃, B₁, and B₂ denote predetermined constants: dₘᵢₙ(i₁(m,n)), dₘᵢₙ(i₂(m,n)), and dₘᵢₙ(i₃(m,n)) denote the first minimum distances of input pixels having i₁(m,n), i₂(m,n), and i₃(m,n); and dₒₚₜ(i₃(m,n)), dₘᵢₙ(N₁₂), and dₒₚₜ(N₁₂) denote the first optimum distance on i₃(m,n), a second minimum distance, and a second optimum distance, respectively.

After operation 14, at operation 16, the multi-valued luminance levels i₁(m,n), i₂(m,n), and i₃(m,n) are converted into bi-valued luminance levels, using the threshold values t₁(m,n), t₂(m,n) and t₃(m,n). That is, a corrected multi-valued luminance level is compared with one of the threshold values t₁(m,n), t₂(m,n) or t₃(m,n), and then the bi-valued luminance level is determined to be a white or black level according to the compared result. Here, the corrected multi-valued luminance level is referred to as the multi-valued luminance level that is corrected using errors of the predetermined bi-valued luminance level.

Hereinafter, an image conversion apparatus, according to an aspect of the present invention, to perform the aforementioned image conversion method will be described regarding its structure and operation.

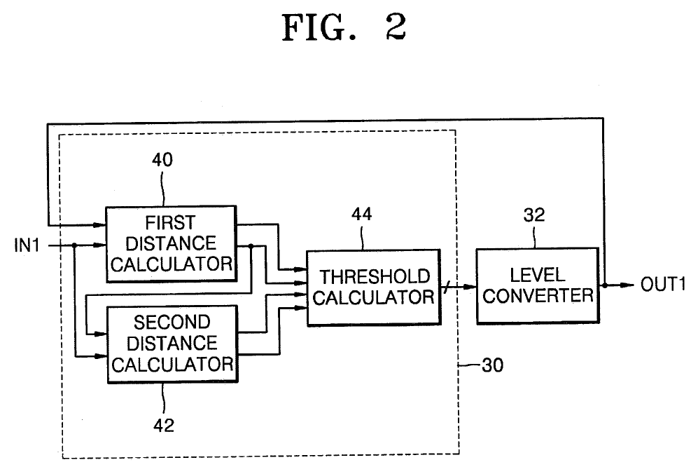

FIG. 2 is a block diagram of the image conversion apparatus to perform the image conversion method of FIG. 1. The image conversion apparatus of FIG. 2 includes a threshold value generator 30 and a level converter 32.

The threshold value generator 30 of FIG. 2 produces threshold values for respective color components considering at least two of at least three color components that the input pixel has as the same color component, and outputs the threshold values to the level converter 32. To this end, the threshold value generator 30 may include a first distance calculator 40, a second distance calculator 42A, and a threshold value calculator 44.

In the operations of the image conversion apparatus of FIG. 2, the first distance calculator 40 performs the aforementioned operation 10. In detail, the first distance calculator 40 calculates the first optimum distance, which is the optimum distance between the output pixels having the bi-valued luminance levels, with regard to the at least two color components from the multi-valued luminance levels input via the input terminal IN1, by equations 1 and 2, and then outputs the calculated first optimum distance to the threshold value calculator 44. Also, the first distance calculator 40 calculates the first minimum distance, which is the distance between the minor pixel nearest to the input pixel and the input pixel with regard to the at least two color components, from the bi-valued luminance levels input from the level converter 32, and then outputs the calculated first minimum distance to the threshold value calculator 44.

At this time, the second distance calculator 42A performs operation 12. In detail, the second distance calculator 42 (renumbered 42A) calculates the second optimum distance, which is the optimum distance between the output pixels having one of the at least two color components, from the multi-valued luminance level input via the input terminal IN1, and outputs the calculated second optimum distance to the threshold value calculator 44. Also, the second distance calculator 42A receives the first minimum distances calculated by the first distance calculator 40 with respect to the at least two color components, determines the shorter distance from the received first minimum distances as a second minimum distance, and outputs the determined second minimum distance to the threshold value calculator 44.

Hereinafter, the second distance calculator 42A illustrated in FIG. 2, according to an aspect of the present invention, will be described in terms of its structure and operations.

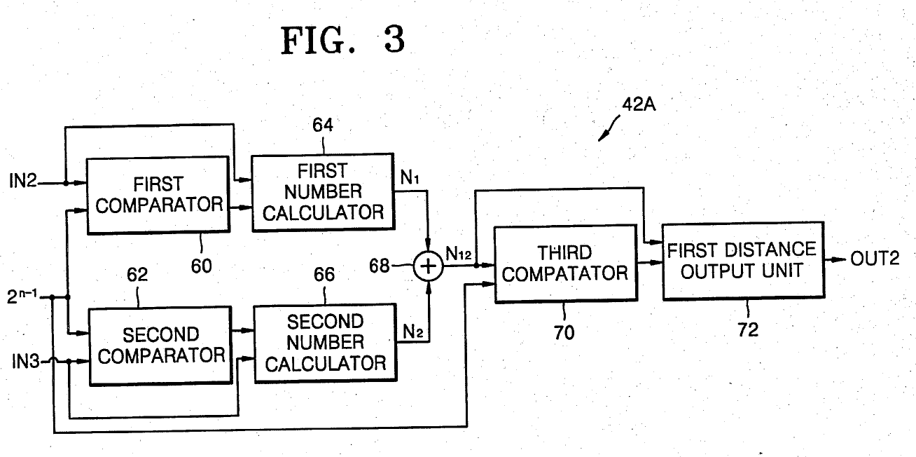

FIG. 3 is a block diagram of the second distance calculator 42 (renumbered 42A) of FIG. 2, according to an aspect of the present invention. Referring to FIG. 3, the second distance calculator 42A includes first through third comparators 60, 62, and 70, first and second number calculators 64 and 66, a first adder 68, and a first distance output unit 72.

The first comparator 60 of FIG. 3 receives the multi-valued luminance level i₁(m,n) of the first color component which is one of the two color components via the input terminal IN2, compares the multi-valued luminance level i₁(m,n) with the intermediate luminance level 2ⁿ⁻¹, and outputs a first command result to the first number calculator 64. At this time, based on the comparison result input from the first comparator 60, the first number calculator 64 calculates the first number N1 of minor pixels on the first color component from 2ⁿ⁻¹ and the multi-valued luminance level i₁(m,n) of the first color component, and outputs the calculated first number N1 to the first adder 68. That is, if it is recognized that the multi-valued luminance level i₁(m,n) is less than or the same as the intermediate luminance level 2ⁿ⁻¹, referring to the first compared result input from the first comparator 60, the first number calculator 64 determines the multi-valued luminance levels i₁(m,n) as the first number N1. On the contrary, if it is recognized that the multi-valued luminance level i₁(m,n) is larger than the intermediate luminance level 2ⁿ⁻¹ through the first compared result input from the first comparator 60, the first number calculator 64 determines a value obtained by subtracting the multi-valued luminance level i₁(m,n) from 2ⁿ as the first number N1. That is, the first comparator 60 and the first number calculator 64 of FIG. 3 calculate the first number N1 by the equation 5.

The second comparator 62 compares the intermediate luminance level 2ₙ₋₁, and the multi-valued luminance level i₂(m,n) on the second color component, which is the other of the two color components, and outputs a second compared result to the second number calculator 66. At this time, based on the second compared result input from the second comparator 62, the second number calculator 66 calculates the second number N2 of minor pixels for the second color component from the multi-valued luminance level i₂(m,n) for the second color component and the intermediate luminance level 2ⁿ⁻¹, and outputs the calculated second number N2 to the first adder 68. For instance, if it is recognized that the multi-valued luminance level i₂(m,n) is less than or the same as the intermediate luminance level 2ⁿ⁻¹, referring to the second compared result input from the second comparator 62, the second number calculator 66 determines the multi-valued luminance level i₂(m,n) as the second number N2. However, if it is recognized that the multi-valued luminance level i₂(m,n) is larger than the intermediate luminance level 2ⁿ⁻¹, referring to the second compared result input from the second comparator 62, the second number calculator 66 determines a value obtained by subtracting the multi-valued luminance levels i₂(m,n) from 2ⁿ as the second number N2. That is, the second comparator 62 and the second number calculator 66 of FIG. 3 calculate the second number N2 by equation 6.

To perform the aforementioned equation 4, the first adder 68 adds the first number N1 input from the first number calculator 64 and the second number N2 input from the second number calculator 66, and outputs an addition result N₁₂ to the third comparator 70.

Then, the third comparator 70 compares the addition result N₁₂ input from the first adder 68 and the intermediate luminance level 2ⁿ⁻¹, and outputs a third compared result to the first distance output unit 72. Next, based on the third compared result input from the third comparator 70 as shown in equation 3, the first distance output unit 72 calculates the second optimum distance from 2ⁿ⁻¹ and the addition result N₁₂ input from the first adder 68, and outputs the second optimum distance to the threshold value calculator 44 via an output terminal OUT2.

To perform operation 14, the threshold value calculator 44 calculates threshold values for respective color components from the first optimum distances and the first minimum distances input from the first distance calculator 40, and the second optimum distance and the second minimum distance input from the second distance calculator 42A , and outputs the calculated threshold values to the level converter 32.

Hereinafter, the threshold value calculator 44A illustrated in FIG. 2, according to an aspect of the present invention, will be described in terms of its structure and operations.

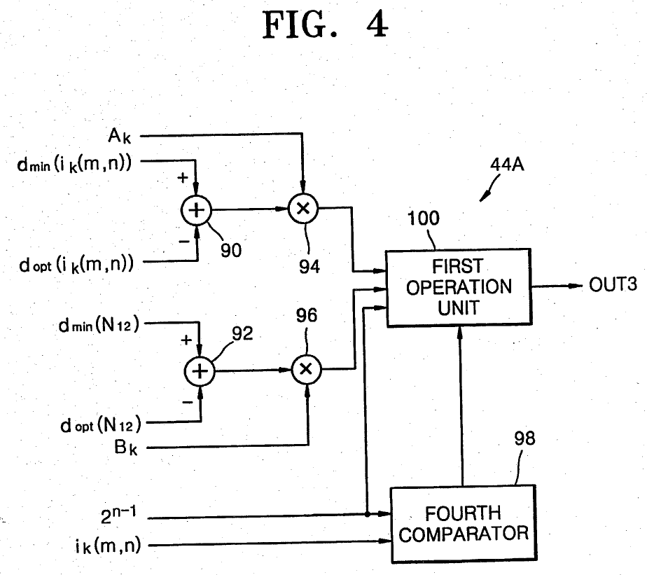

FIG. 4 is a block diagram of the threshold value calculator 44 (renumbered 44A) of FIG. 2, according to an aspect of the present invention. The threshold value calculator 44A includes first and second subtracters 90 and 92, first and second multipliers 94 and 96, a fourth comparator 98, and a first operation unit 100.

The first subtracter 90 subtracts a first optimum distance dopt (ik(m,n)]) from a first minimum distance dmin (ik(m,n)]), and outputs a subtraction result to the first multiplier 94 (here, k is 0 or 1). The second subtracter 92 subtracts the second optimum distance dₒₚₜ(N₁₂) from the second minimum distance dₘᵢₙ(N₁₂), and outputs the subtraction result to the second multiplier 96. At this time, the first multiplier 94 multiplies the subtraction result output from the first subtracter 90 by a first constant Ak, and outputs a first multiplication result to the first operation unit 100. The second multiplier 96 multiplies the subtraction result output from the second subtracter 92 by a second constant Bk, and outputs a second multiplication result to the first operation unit 100.

The fourth comparator 98 compares the multi-valued luminance level ik(m,n) and the intermediate luminance level 2ⁿ⁻¹, and outputs a fourth compared result to the first operation unit 100. Next, based on the fourth compared result input from the fourth comparator 98, the first operation unit 100 adds or subtracts the first and second multiplication results output from the first and second multipliers 94 and 96 and/or from the intermediate luminance level 2ⁿ⁻¹, and outputs the addition or subtraction result to the level converter 32 via an output terminal OUT3 as a threshold value tk(m,n) for color component. That is, if it is recognized, through the comparison result input from the fourth comparator 98, that the multi-valued luminance level ik(m,n) is smaller than or the same as the intermediate luminance level 2ⁿ⁻¹, the first operation unit 100 adds the first and second multiplication results input from the first and second multipliers 94 and 96 and the intermediate luminance level 2ⁿ⁻¹, and outputs an addition result to the level converter 32 via the output terminal OUT3 as a threshold value tk(m,n) for color component. On the contrary, if it is recognized through the fourth compared result input from the fourth comparator 98 that the multi-valued luminance level ik(m,n) is larger than the intermediate luminance level 2ⁿ⁻¹, the first operation unit 100 subtracts the first and second multiplication results input from the first and second multipliers 94 and 96 from the-intermediate luminance level 2ⁿ⁻¹, and outputs a subtraction result indicative thereof to the level converter 32 via the output terminal OUT3 as a threshold value tk(m,n) for color component. In conclusion, the threshold value calculator 44A of FIG. 4 calculates the threshold value t₁(m,n) or t₂(m,n) expressed in equation 7.

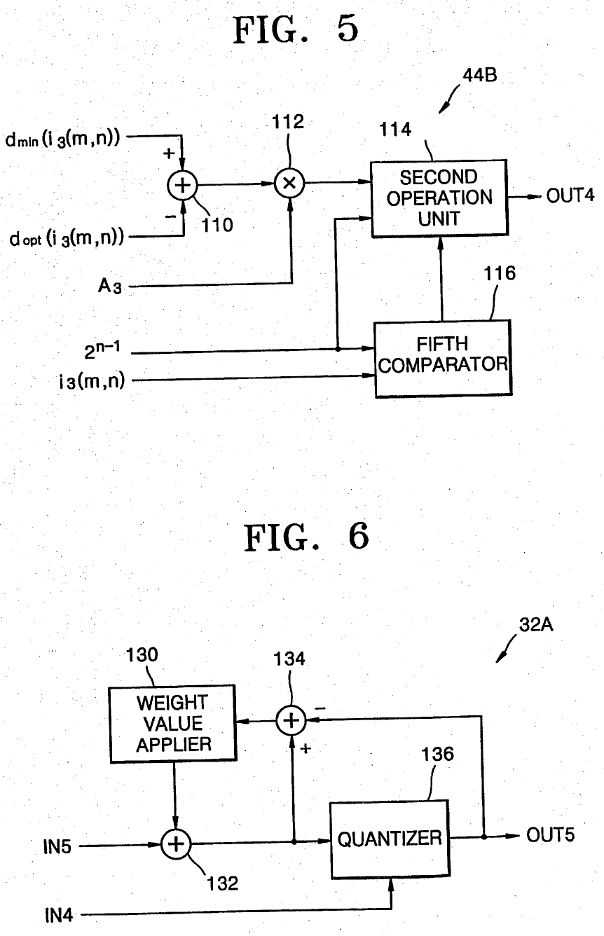

FIG. 5 is a block diagram of the threshold value calculator 44 (renumbered 44B) illustrated in FIG. 2, according to an aspect of the present invention. The threshold value calculator 44B includes a third subtracter 110, a third multiplier 112, a second operation unit 114, and a fifth comparator 116.

The third subtracter 110 of FIG. 5 subtracts a first optimum distance dₒₚₜ(i₃(m,n)) from a first optimum distance dₘᵢₙ(i₃(m,n)), and outputs a subtraction result to the third multiplier 112. Next, the third multiplier 112 multiplies the subtraction result input from the third subtracter 110 by a third constant A3, and outputs a multiplication result to the second operation unit 114. The fifth comparator 116 compares the multi-valued luminance value i₃(m,n) with the intermediate luminance level 2ⁿ⁻¹, and outputs a fifth compared result to the second operation unit 114. Then, based on the fifth compared result input from the fifth comparator 116, the second operation unit 114 adds or subtracts the multiplication results input from the third multiplier 98 and/or from the intermediate luminance level 2ⁿ⁻¹, and outputs an addition result or a subtraction result to the level converter 32 via an output terminal OUT4 as a threshold value t₃(m,n). For instance, if it is recognized that multi-valued luminance level i₃(m,n) is smaller than or the same as the intermediate luminance level 2ⁿ⁻¹, referring to the fifth compared result input from the fifth comparator 115, the second operation unit 114 subtracts the multiplication result, which is output from the third multiplier 112, from the intermediate luminance level 2ⁿ⁻¹, and outputs the subtraction result to the level converter 32 via the output terminal OUT4 as the threshold value t₃(m,n). On the contrary, if it is recognized that the multi-valued luminance level i₃(m,n) is larger than the intermediate luminance level 2ⁿ⁻¹ through the fifth compared result input from the fifth comparator 115, the second operation unit 114 adds the multiplication result input from the third multiplier 112 and the intermediate luminance level 2ⁿ⁻¹, and outputs an addition result to the level converter 32 via the output terminal OUT4 as the threshold value t₃(m,n). In conclusion, the threshold value calculator 44B of FIG. 5 calculates the threshold value t₃(m,n) by equation 7.

The level converter 32, which performs operation 16, converts the multi-valued luminance value into the bi-valued luminance level with reference to the threshold values output from the threshold value generator 30, and outputs the bi-valued luminance level via the output terminal OUT1. For instance, the level converter 32 converts the multi-valued luminance level of an input pixel having the color component into the bi-valued luminance level, using a threshold value tk(m,n) output from the first operation unit 100, and converts the multi-valued luminance level of the input pixel having a bright color component into the bi-valued luminance level, using the threshold value t₃(m,n) output from the second operation unit 114.

Hereinafter, the structure and operations of the level converter 32 (renumbered 32A) illustrated in FIG. 2, according to an aspect of the present invention, will be described.

FIG. 6 is a block diagram of a preferred embodiment 32A of the level converter 32A of FIG. 2, according to an aspect of the present invention. The level converter 32A includes a weight value applier 130, a second adder 132, a fourth subtracter 134, and a quantizer 136.

According to an aspect of the present invention, the level converter 32 of FIG. 2 may be realized as the quantizer 136 illustrated in FIG. 6. The quantizer 136 compares a corrected multi-valued luminance level and a threshold value input via an input terminal IN4, and outputs a compared result as the bi-valued luminance level to an output terminal OUT5. Here, the ‘corrected multi-valued luminance level’ is a result of correcting the multi-valued luminance level that is input via an input terminal IN5 using errors of a predetermined bi-valued luminance level.

The quantizer 136 determines the bi-valued luminance level according to a size of the multi-valued luminance level of the above result by the following equation 8:

$${b}_{1} ( m , n ) = \{ \begin{matrix}0 , if {u}_{1} ( m , n ) \leq {t}_{1} ( m , n ) \\ {2}^{n} , if {u}_{1} ( m , n ) > {t}_{1} ( m , n )\end{matrix} \\ {b}_{2} ( m , n ) = \{ \begin{matrix}0 , if {u}_{2} ( m , n ) \leq {t}_{2} ( m , n ) \\ {2}^{n} , if {u}_{2} ( m , n ) > {t}_{2} ( m , n )\end{matrix} \\ {b}_{3} ( m , n ) = \{ \begin{matrix}0 , if {u}_{3} ( m , n ) \leq {t}_{3} ( m , n ) \\ {2}^{n} , if {u}_{3} ( m , n ) > {t}_{3} ( m , n )\end{matrix} \qquad ( 8 )$$

wherein b1(m,n), b2(m,n), and b3(m,n) denote the bi-valued luminance levels that are converted from the multi-valued luminance levels i₁(m,n), i₂(m,n) and i₃(m,n), respectively, and u1(m,n), u2(m,n) and u3(m,n) denote corrected multi-valued luminance levels that are corrected from the multi-valued luminance levels i₁(m,n), i₂(m,n) and i₃(m,n), respectively.

The aforementioned level converter 32A may include the weight value applier 130, and the second adder 132 and the fourth subtracter 134 so as to measure the corrected multi-valued luminance levels. The fourth subtracter 134 subtracts the bi-valued luminance level output from the quantizer 136 from the corrected multi-valued luminance level input from the second adder 132, and outputs a subtraction result to the weight value applier 130. Next, the weight value applier 130 applies predetermined weight values to the subtraction result output from the fourth subtracter 134, adds the results of applying the weight values, i.e., error diffusion coefficients to subtraction results output from the fourth subtracter 134, and outputs an addition result indicative thereof to the second adder 132 as a sum of errors. In other words, the weight value applier 130 applies weight values to errors of pixels adjacent to the input pixel, and adds the application results. The second adder 132 adds the sum of errors input from the weight value applier 130 and the multi-valued luminance level input via the input terminal IN5, and outputs the addition result as the corrected multi-valued luminance level to the quantizer 136 and the fourth subtracter 134.

As described above, with a method and apparatus to convert a level of an image according to an aspect of the present invention, it is possible to improve a quality of an output image having a bi-valued luminance level by regularly distributing parts corresponding to color components of an input pixel in a bright portion of the bi-valued luminance level when converting a multi-valued luminance level into a bi-valued luminance level.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method to convert a level of an image, the method comprising:
considering at least two color components that an input pixel has as the same color component, and producing threshold values for each color component; and
converting a multi-valued luminance level of the input pixel into a bi-valued luminance level using the threshold values.

2. The method of claim 1, wherein the at least two color components are cyan and magenta components.

3. The method of claim 1, wherein the considering of the at least two color components comprises:
obtaining a first optimum distance between output pixels having the bi-valued luminance levels, for the at least two color components according to the multi-valued luminance level, and obtaining a first minimum distance between a minor pixel nearest to the input pixel and the input pixel for the at least two color components;
obtaining a second optimum distance between the output pixels having one of the at least two color components according to the multi-valued luminance level, and determining a second minimum distance being shorter than the first minimum distance, which is obtained for the at least two color components; and
obtaining the threshold values of the color components using the first optimum distances, the first minimum distance, the second optimum distance, and the second minimum distance.

4. The method of claim 3, wherein the second optimum distance is obtained by the following equation:
$${d}_{opt} ( {N}_{12} ) = \{ \begin{matrix}\frac{1}{\sqrt{\frac{{N}_{12}}{{2}^{n}}}} , if {N}_{12} \leq {2}^{n - 1} \\ \frac{1}{\sqrt{1 - \frac{{N}_{12}}{{2}^{n}}}} , if {N}_{12} > {2}^{n - 1}\end{matrix}$$
wherein dₒₚₜ(N₁₂) denotes the second optimum distance, N₁₂ denotes a sum of N1 and N2, N1 denotes a number of minor pixels for one of the at least two color components, N2 denotes a number of minor pixels for the other of the at least two color components, and the multi-valued luminance level falls within a range of 0-2ⁿ.

5. The method of claim 4, wherein the N1 and N2 are calculated by the following equation:
$${N}_{1} = \{ \begin{matrix}{i}_{1} ( m , n ) , if {i}_{1} ( m , n ) \leq {2}^{n - 1} \\ {2}^{n} - {i}_{1} ( m , n ) , if {i}_{1} ( m , n ) > {2}^{n - 1}\end{matrix} \\ {N}_{2} = \{ \begin{matrix}{i}_{2} ( m , n ) , if {i}_{2} ( m , n ) \leq {2}^{n - 1} \\ {2}^{n} - {i}_{2} ( m , n ) , if {i}_{2} ( m , n ) > {2}^{n - 1}\end{matrix}$$
wherein i₁(m,n) and i₂(m,n) denote multi-valued luminance levels for color components of the input pixel positioned at a point (m,n), respectively.

6. The method of claim 3, wherein in the obtaining of the threshold values, the threshold values t₁(m,n), t₂(m,n) and t₃(m,n) of the color components are determined by the following equation:
$${t}_{1} ( m , n ) = \{ \begin{matrix}{2}^{n - 1} - {A}_{1} \times [ {d}_{min} ( {i}_{1} ( m , n ) ) - {d}_{opt} ( {i}_{1} ( m , n ) ) - {B}_{1} \times ( {d}_{min} ( {N}_{12} ) - {d}_{opt} ( {N}_{12} ) ) ] , if {i}_{1} ( m , n ) \leq {2}^{n - 1} \\ {2}^{n - 1} + {A}_{1} \times [ {d}_{min} ( {i}_{1} ( m , n ) ) - {d}_{opt} ( {i}_{1} ( m , n ) + {B}_{1} \times ( {d}_{min} ( {N}_{12} ) - {d}_{opt} ( {N}_{12} ) ) ] , if {i}_{1} ( m , n ) > {2}^{n - 1}\end{matrix} , \\ {t}_{2} ( m , n ) = \{ \begin{matrix}{2}^{n - 1} - {A}_{2} \times [ {d}_{min} ( {i}_{2} ( m , n ) ) - {d}_{opt} ( {i}_{2} ( m , n ) ) - {B}_{2} \times ( {d}_{min} ( {N}_{12} ) - {d}_{opt} ( {N}_{12} ) ) ] , if {i}_{2} ( m , n ) \leq {2}^{n - 1} \\ {2}^{n - 1} + {A}_{2} \times [ {d}_{min} ( {i}_{2} ( m , n ) ) - {d}_{opt} ( {i}_{2} ( m , n ) + {B}_{2} \times ( {d}_{min} ( {N}_{12} ) - {d}_{opt} ( {N}_{12} ) ) ] , if {i}_{2} ( m , n ) > {2}^{n - 1}\end{matrix} \\ {t}_{3} ( m , n ) = \{ \begin{matrix}{2}^{n - 1} - {A}_{3} \times [ {d}_{min} ( {i}_{3} ( m , n ) ) - {d}_{opt} ( {i}_{3} ( m , n ) ) ] , if {i}_{3} ( m , n ) \leq {2}^{n - 1} \\ {2}^{n - 1} + {A}_{3} \times [ {d}_{min} ( {i}_{3} ( m , n ) ) - {d}_{opt} ( {i}_{3} ( m , n ) ] , if {i}_{3} ( m , n ) > {2}^{n - 1}\end{matrix}$$
wherein A₁, A₂, A₃, B₁, and B₂ denote predetermined constants,dₘᵢₙ(i₁(m,n)), dₘᵢₙ(i₂(m,n)), and dₘᵢₙ(i₃(m,n)) denote the first minimum distance on the multi-valued luminance levels i₁(m,n), i₂(m,n), and i₃(m,n), respectively,dₒₚₜ(i₁(m,n)), dₒₚₜ(i₂(m,n)), and dₒₚₜ(i₃(m,n)) denote the first optimum distances on the multi-valued luminance levels i₁(m,n), i₂(m,n), and i₃(m,n), respectively, and dₘᵢₙ(N₁₂) and dₒₚₜ(N₁₂) denote the second minimum distance, and the second optimum distance, respectively.

7. The method of claim 1, wherein in the converting of the multi-valued luminance level, the bi-valued luminance level is determined as white or black according to a result of comparing a corrected multi-valued luminance level with the threshold value, where
the corrected multi-valued luminance level is obtained from the multi-valued luminance level using errors of a previously obtained bi-valued luminance level.

8. An apparatus to convert a level of an image, the apparatus comprising:
a threshold value generator considering at least two color components an input pixel has as the same color component, producing threshold values for the color components, and outputting the produced threshold values; and
a level converter to convert a multi-valued luminance level of the input pixel into a bi-valued luminance level with reference to the threshold values, and outputting the bi-valued luminance level.

9. The apparatus of claim 8, wherein the threshold value generator comprises:
a first distance calculator calculating a first optimum distance between output pixels having the bi-valued luminance levels, for the at least two color components from the multi-valued luminance level, and calculating a first minimum distance between a minor pixel nearest to the input pixel and the input pixel for the at least two color components from the bi-valued luminance level;
a second distance calculator calculating a second optimum distance between the output pixels having one of the at least two color components, from the multi-valued luminance level, and determining a second minimum distance being shorter than the first minimum distance calculated for the at least two color components; and
a threshold value calculator calculating the threshold values for the color components using the first optimum distances and the first minimum distance input from the first distance calculator and the second optimum distance and the second minimum distance input from the second distance calculator, and outputting the calculated threshold values.

10. The apparatus of claim 9, wherein the second distance calculator comprises:
a first comparator comparing the multi-valued luminance level of a first color component, which is one of the at least two color components, with an intermediate luminance level and outputting a first compared result indicative thereof;
a second comparator comparing the multi-valued luminance level of a second color component, which is the other of the at least two color components, with the intermediate luminance level and outputting a second compared result indicative thereof;
a first number calculator calculating a first number N1 of minor pixels of the first color component from 2ⁿ⁻¹, which is the intermediate luminance level, and the multi-valued luminance level of the first color component, based on the first compared result from the first comparator;
a second number calculator calculating a second number N2 of minor pixels the second color component from 2ⁿ⁻¹, which is the intermediate luminance level, and the multi-valued luminance level of the second color component, based on the second compared result from the second comparator;
a first adder adding the first number N1 and the second number N2 and outputting an addition result indicative thereof;
a third comparator comparing the addition result with the intermediate luminance level and outputting a third compared result indicative thereof; and
a first distance output unit calculating a second optimum distance from 2ⁿ⁻¹ and the addition result, based on the third compared result input from the third comparator,
wherein the intermediate luminance level is a mean value of luminance levels comprised in the multi-valued luminance level.

11. The apparatus of claim 9, wherein the threshold value calculator comprises:
a first subtracter subtracting the first optimum distance from the first minimum distance and outputting a first subtraction result indicative thereof;
a second subtracter for subtracting the second optimum distance from the second minimum distance and outputting a second subtraction result indicative thereof;
a first multiplier multiplying the subtraction result from the first subtracter by a first constant and outputting a first multiplication result indicative thereof;
a second multiplier multiplying the subtraction result from the second subtracter by a second constant and outputting a second multiplication result indicative thereof;
a fourth comparator comparing the multi-valued luminance level with the intermediate luminance level and outputting a compared result indicative thereof; and
a first operation unit adding or subtracting the first and second multiplication results input from the first and second multipliers with or from the intermediate luminance level, and based on the compared result from the fourth comparator, outputting the addition or subtraction as the threshold values,
wherein the threshold values output from the first operation unit correspond to the threshold values of the color components.

12. The apparatus of claim 9, wherein the threshold value calculator comprises:
a third subtracter subtracting the first optimum distance from the first minimum distance and outputting a subtraction result indicative thereof;
a third multiplier multiplying the subtraction result from the third subtracter by a third constant and outputting a multiplication result indicative thereof;
a fifth comparator comparing the multi-valued luminance level with an intermediate luminance level and outputting a compared result indicative thereof; and
a second operation unit for adding or subtracting the subtraction result from the third multiplier with or from the intermediate luminance level, and, based on the compared result from the fifth comparator, outputting the addition or subtraction result as the threshold value,
wherein the threshold value output from the second operation unit corresponds to the threshold value for a bright color component.

13. The apparatus of claim 9, wherein the level converter comprises a quantizer to compare a corrected multi-valued luminance level with the threshold value and outputting a comparison result indicative thereof as the bi-valued luminance level, where
the corrected multi-valued luminance level is obtained from the multi-valued luminance level using errors of a previously obtained bi-valued luminance level.

14. The apparatus of claim 13, wherein the level converter further comprises:
a fourth subtracter subtracting the bi-valued luminance level from the corrected multi-valued luminance level and outputting a subtraction result indicative thereof;
a weight value applier applying predetermined weight values to the subtraction result input from the fourth subtracter and outputting application results indicative thereof, adding the application results and outputting a first addition result indicative thereof, and outputting the first addition result as a sum of errors; and
a second adder adding the sum of errors and the multi-valued luminance level and outputting a second addition result indicative thereof, and outputting the second addition result as the corrected multi-valued luminance level to the quantizer.

15. The method of claim 2, wherein the at least two color components are cyan and magenta components and the second minimum distance is a distance between the output pixels having the cyan or magenta components nearest to the input pixel positioned.

16. The method of claim 3, wherein the first optimum distance and the second optimum distance are simultaneously obtained, the second optimum distance is obtained prior to obtaining the first optimum distance, or the second optimum distance is obtained after obtaining the first optimum distance.

17. The method of claim 4, wherein the intermediate luminance level denotes an intermediate level among luminance levels comprised in the multi-valued luminance level.

18. The apparatus of claim 9, wherein the at least two color components are cyan and magenta components and the second minimum distance is a distance between the output pixels having the cyan or magenta components nearest to the input pixel positioned.

19. The apparatus of claim 9, wherein the first optimum distance and the second optimum distance are simultaneously calculated, the second optimum distance is calculated prior to obtaining the first optimum distance, or the second optimum distance is calculated after obtaining the first optimum distance.

20. A method to convert a level of an image, comprising:
regularly distributing parts corresponding to color components of an input pixel in a bright portion of a bi-valued luminance level when converting a multi-valued luminance level into the bi-valued luminance level to improve a quality of an output image having the bi-valued luminance level.
